(19) United States
(12) Patent Application Publication
(10) Pub. No.: US 2012/0280643 A1
(43) Pub. Date: Nov. 8, 2012

(54) METHOD AND DEVICE FOR OPERATING A POWER TOOL

(76) Inventor: Heiko ROEHM, Stuttgart (DE)

(21) Appl. No.: 13/454,950

(22) Filed: Apr. 24, 2012

(30) Foreign Application Priority Data
May 3, 2011 (DE) 10 2011 075 141.6

(51) Int. Cl. H02P 6/08

(52) U.S. Cl. 318/434

(57) ABSTRACT

In a method for operating a power tool having an electric motor which is supplied with operating current and operating voltage during the operation, a root-mean-square value of the power output of the electric motor is regulated upon exceeding a predefined limiting value of the electrical power output of the electric motor in such a way that it maximally reaches the limiting value.

### BACKGROUND OF THE INVENTION

1. Field of the Invention

The present invention relates to a method and a device for operating a power tool.

2. Description of Related Art

Battery-operated power tools, for example cordless screwdrivers, cordless combi drills, cordless circular saws, cordless jigsaws, cordless planers, cordless percussion drills, cordless impact drills, may be subjected to so much load that the lifetime of mechanical or electrical components is reduced.

Before the blocked situation is reached, there are load ranges in which the power tool may not be continuously operated since one or multiple components heat up to a level above their admissible thermal level and/or fail mechanically when operated at this load level for a prolonged period of time.

In battery-operated power tools, the thermal resistance is typically increased by the use of high-temperature resistant or low-resistance components; however, this measure only delays the point in time of the thermal failure in most cases. For mechanical components, either very robust or larger-sized components are used which, however, are typically more expensive, larger and/or heavier.

Alternatively, an electrical interruption is known which causes, upon reaching a certain current level, the circuit to be electrically disconnected. The necessary components are expensive and may impair the performance of the power tool, depending on the design. When the current limits are fixed, an influence over time is not taken into account, for example, so that short-lived current peaks are not allowed although the power tool could tolerate them.

A method is known from published German patent application document DE 10 2008 003 786 A1 in which an advance calculation and an advance energy management are used. The current-time-temperature-relationship of critical components of the power tool is stored as a mathematical formula. The future temperature is calculated from the actual current profile, and the performance of the critical component is delimited before a critical temperature is measured. The possibility of making maximum use of the power tool performance is advantageous in this case. However, it is not possible to sufficiently take into account mechanical limits such as those of the tool gear.

### BRIEF SUMMARY OF THE INVENTION

The present invention is directed at a method for operating a power tool having an electric motor which is supplied with operating current and operating voltage during the operation.

It is proposed that a root-mean-square value of the power output of the electric motor is regulated upon reaching or exceeding a predefined limiting value of an electrical power output of the electric motor in such a way that the root-mean-square value maximally reaches the limiting value.

The root-mean-square value of the power output of the electric motor is to be understood as the power output whose mean value within one or over multiple periods of time corresponds to the mean value of the power output, for example during a discontinuous operation. An advantageous period of time is in the range of several ten microseconds, e.g., approximately 0.0625 msec.

Using this approach, it may be advantageously achieved that the thermal and also the mechanical robustness of the power tool is improved. Smaller and also more cost-effective components may be used. The electromagnetic compatibility of the power tool is improved since the number of commutation changes is reduced in the high current range. In electric motors having carbon brushes, the carbon lifetime may be extended since the carbon brushes are loaded to a lesser extent.

According to one advantageous embodiment, the power output may be adjusted by modulating the operating current and/or the operating voltage, in particular by a discontinuous operation. An advantageous type of modulation is the pulse width modulation of the operating current and/or the operating voltage. It is, however, also possible to use other types of modulation such as pulse frequency modulation (PFM), pulse amplitude modulation (PAM), pulse code modulation (PCM) or pulse phase modulation (PPM).

According to one advantageous embodiment, the operating current and/or the operating voltage may be detected continuously or quasi-continuously. The power input may be derived from the values of the operating current and/or the operating voltage, and the power output of the electric motor may be derived therefrom in a simple manner. Quasi-continuous is to be understood to mean that the values are detected frequently but with short pauses in-between the detection of the measuring values.

According to one advantageous embodiment, the power output of the electric motor may be compared continuously or quasi-continuously to the limiting value of the power output. In this way, it may be quickly detected when the power output approaches or reaches the limiting value.

The control of the power output may be advantageously switched on when the power output exceeds the limiting value, and switched off when the regulation amplitude becomes zero or the root-mean-square value of the power output drops to a value that is lower than or equal to the limiting value.

In another aspect of the present invention, the present invention is directed to a device for carrying out the method according to at least one of the previously described embodiments.

It is proposed that a monitoring device is provided, a control device being controllable upon exceeding a predefined limiting value of an electrical power output of the electric motor in such a way that a power output of the electric motor may be directed in such a way that it maximally reaches the limiting value.

The control device is advantageously activatable as long as there is a chance that the limiting value may be exceeded, so that a thermal or mechanical overload of the components of the power tool may be avoided.

According to one advantageous refinement, a measuring device for continuously or quasi-continuously measuring the operating current and/or the operating voltage may be provided so that an approach to the limiting value may be quickly recognized.

According to one advantageous refinement, a comparator may be provided to continuously or quasi-continuously compare a power output of the electric motor to the limiting value of the power output. Reaching or exceeding the limiting value may be recognized quickly, and exceeding may be prevented by activating the control device.

According to another aspect of the present invention, a power tool is proposed, in particular a battery-operated power tool, including a device having a monitoring device, a control device being controllable upon exceeding a predefined limiting value of an electrical power output of the electric motor in such a way that a power output of the electric motor may be directed in such a way that it maximally reaches the limiting value.

The electric motor may be advantageously a universal motor, or also a DC motor or an AC motor. The power tool may, for example, include: cordless screwdrivers, cordless combi drills, cordless circular saws, cordless jigsaws, cordless planers, cordless percussion drills, cordless impact drills.

### BRIEF DESCRIPTION OF THE DRAWINGS

FIG. 1 shows a schematic representation of an advantageous exemplary embodiment of a cordless screwdriver according to the present invention.

FIG. 2 shows an idealized motor characteristic curve of the cordless screwdriver from FIG. 1 having a control range.

### DETAILED DESCRIPTION OF THE INVENTION

In the figures, identical or equal components are provided with identical reference symbols.

The present invention is described as an example with reference to a cordless screwdriver.

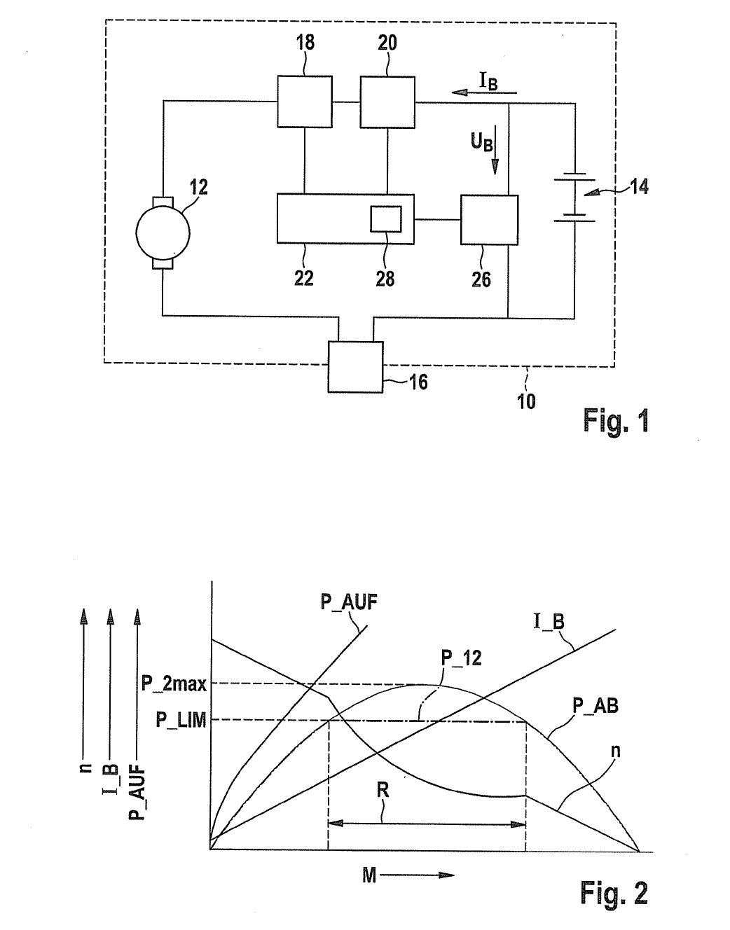

FIG. 1 shows a schematic representation of a hand-held power tool 10 designed as a cordless screwdriver. Power tool 10 has an electric motor 12 as the drive system which is supplied by a battery pack 14. The battery pack may be detachably fastened to power tool 10 or be directly fixedly installed.

In the circuit between battery pack 14 and electric motor 12, an operating element 16 is situated via which a user may open or close the circuit. A control device 18 as well as a current measuring device 20, and a voltage measuring device 26 are situated in the circuit.

Current measuring device 20 measures operating current I_B, and voltage measuring device 26 measures operating voltage U_B of electric motor 12.

A monitoring device 22 includes a regulating and/or control unit 28 in which the signal processing and the signal generation take place for application of operating current U_I and operating voltage U_B to electric motor 12. Other parameters are also stored there, such as a function f(P_AUF)=P_AB which describes the relationship between electrical power input P_AUF and power output P_AB of electric motor 12.

During regular operation, operating current I_B and operating voltage U_B are continuously measured. Using the measuring values, operating capacity P_B is ascertained in regulating and/or control unit 28 from the product of operating current I_B and operating voltage U_B which corresponds to power input P_AUF. In the case of known electric motor 12 or known characteristic variables of electric motor 12, its electrical power output P_AB may be deduced from electrical power input P_AUF; for example, power output P_AB is a function of power input P_AUF.

If operating capacity P_B exceeds a predefined limiting value P_LIM, control device 18 is activated which keeps a root-mean-square value of operating capacity P_B below limiting value P_LIM or allows it to increase maximally up to limiting value P_{–}LIM with the aid of a modulation (for example, pulse width modulation PWM or the like) of operating current I_B and/or operating voltage U_B. The root-mean-square value of operating capacity P_B is to be understood as the mean value over time of the product of modulated operating current I_B and/or operating voltage U_B. The root-mean-square value of operating capacity P_B or the root-mean-square value of power input P_AUF derived therefrom yields the root-mean-square value of power output P_AB during the modulation operation of control device 18.

Control device 18 generates via switches or alternative control devices a modulated operation, for example a PWM operation or a similar discontinuous operating mode of electric motor 12.

Operating capacity P_B corresponds to power input P_AUF of electric motor 12; however, it is coupled directly to power output P_AB of electric motor 12 as a function of the efficiency of electric motor 12.

As soon as operating capacity P_B drops back to the root-mean-square value of operating capacity P_B, control device 18 is deactivated again. In one alternative specific embodiment (not illustrated), control device 18 is deactivated when operating capacity P_B falls below 95% of limiting value P_LIM, for example.

In this way, the performance level of electric motor 12 may be reliably kept below predefined limiting value P_LIM electrically and mechanically, and the mechanical and electrical system of power tool 10 may be optimized with regard to costs for components, size, weight, and thermal properties.

FIG. 2 shows an idealized motor characteristic curve of electric motor 12 of power tool 10 from FIG. 1. Motor speed n, power input P_AUF, power output P_AB and operating current I_B are plotted against motor torque M. In known systems, the power output increases under increasing load of the electric motor up to maximum power output P_{—}2max, the maximum of P_AB curve, to decrease again during continued load. According to the present invention, power output P_AB will increase under increasing load up to limiting value P_LIM of power output P_AB. Limiting value P_LIM is selected in such a way that it lies securely below maximum power output P_{—}2max, at approximately 80% of maximum power output P_{—}2max, for example, the value being selected as a function of the mechanical components of electric motor 12 or power tool 10.

If power output P_AB increases under increasing load up to limiting value P_LIM of power output P_AB, control device 18 regulates operating current I_B and/or operating voltage U_B in such a way that, during modulated operation, power output P_AB is kept maximally at limiting value P_LIM, despite continuously increasing torque M. This is shown as characteristic curve P_12 whose flanks lie outside control intervention range R on curve P_AB and which runs horizontally within control intervention range R and assumes value P_LIM. P_{—}2max is no longer reached.

The modulated operation does not end until the natural characteristic curve drops back below limiting value P_LIM. The natural characteristic curve is understood as the characteristic curve without control intervention by control device 18. As long as control device 18 is activated, electric motor 12 preferably rotates slower than would be the case without the activation of control device 18. Therefore, characteristic curve n of the rotational speed deviates from a line within control intervention range R and runs below a straight line representing characteristic line n of the rotational speed outside control intervention range R.

What is claimed is:

1. A method for operating a power tool having an electric motor, comprising:
supplying the electric motor with operating current and operating voltage during operation; and
regulating a root-mean-square value of an electrical power output of the electric motor, when the root-mean-square value exceeds a predefined limiting value of the electrical power output of the electric motor, in such a way that the regulated root-mean-square value of the electrical power output does not exceed the predefined limiting value.

2. The method as recited in claim 1, wherein the root-mean-square value of the power output is adjusted by modulating at least one of an operating current and an operating voltage.

3. The method as recited in claim 2, wherein at least one of the operating current and the operating voltage is detected continually.

4. The method as recited in claim 3, wherein the power output of the electric motor is compared continually to the predefined limiting value of the power output.

5. The method as recited in claim 4, wherein the regulating of the root-mean-square value is stopped when the root-mean-square value of the power output drops below the predefined limiting value.

6. A device for controlling an operation of a power tool having an electric motor, the device comprising:
a control unit configured to control the power tool, when a root-mean-square value of an electrical power output of the electric motor exceeds a predefined limiting value, in such a way that the root-mean-square value of the electrical power output is regulated to not exceed the predefined limiting value.

7. The device as recited in claim 6, further comprising:
a measuring device for continually measuring at least one of an operating current and an operating voltage.

8. The device as recited in claim 7, further comprising:
a comparator for continually comparing the electrical power output of the electric motor to the predefined limiting value of the power output.

9. A power tool, comprising:
an electric motor; and
a control unit configured to control the power tool, when a root-mean-square value of an electrical power output of the electric motor exceeds a predefined limiting value, in such a way that the root-mean-square value of the electrical power output is regulated to not exceed the predefined limiting value.
